(19) United States
(12) Patent Application Publication
(10) Pub. No.: US 2003/0133430 A1
(43) Pub. Date: Jul. 17, 2003

(54) Efficient method of improving detection of signals containing repetitive components

(76) Inventors: William D. Dickson, Baltimore, MD (US); Paul A. Kline, Gaithersburg, MD (US)

Correspondence Address: ROBERTS ABOKHAIR & MARDULA, SUITE 1000, 11800 SUNRISE VALLEY DRIVE, RESTON, VA, 20191, US

(21) Appl. No.: 10/228,840

(22) Filed: Aug. 27, 2002

Related U.S. Application Data
(63) Continuation-in-part of application No. 10/159,745, filed on May 31, 2002.
(60) Provisional application No. 60/294,795, filed on May 31, 2001.

(51) Int. Cl. H04B 7/216

(52) U.S. Cl. 370/342

(57) ABSTRACT

A synchronization channel detection method for cellular transmission is disclosed. Said method is based on an algorithm that adds coherent components and deriving an average of the components in a synchronization signal that is repetitively transmitted over a short period of time. This method achieves a detection gain as compared to correlation algorithms.

### CROSS REFERENCE TO RELATED APPLICATIONS

This application is a continuation-in-part of application Ser. No. 10/159,745, filed May 31, 2002, which claims priority under 35 U.S.C. §119(e) from provisional application No. 60/294,795, filed May 31, 2001. The Ser. No. 10/159,745 application and the No. 60/294,795 application is each incorporated by reference herein, in its entirety, for all purposes.

### INTRODUCTION

The present invention relates generally to the field of wireless technology. More particularly, the present invention relates to receiver detection in a wireless system.

### BACKGROUND OF THE INVENTION

The emerging third generation (3G) wireless network supports data, voice and multimedia services. In order to support these services, differing bandwidth and signal quality requirements are present. With the advent of third generation (3G) wireless services, the complexities have increased with mobile terminals having multiple data and voice channels.

Wideband code division multiple access (WCDMA) cellular systems under third generation partnership project (3GPP) and wcdma2000 (3GPP2), collectively referred to as “3G,” allow mobile terminals to transmit at different channels and at different amplitudes. Phase shifting modulation formats help in avoiding signal interference, but providing channel detection is increasingly demanding.

Detection of digital wireless communication signals relies upon being able to distinguish those signals from Gaussian white noise. Simultaneous broadcasts of multiple signals having been encoded to appear as random noise, often referred to as psuedo noise (PN), make it all the more difficult to isolate the synchronization channel signal. According to one proposed system, the synchronization channel signal is broadcast at the front of a downlink slot transmission that has 256 chips.

Signal detection algorithms are typically based on correlation techniques to analyze sampled signals. Various stochastic gradient descent algorithms are in use, including the least mean square (LMS) algorithm (which converges to the minimum mean square error algorithm); the normalized LMS; and the minimum output-energy (MOE) algorithm.

Since WCDMA 3G capacity is bound by the amount of multiple access interference (MAI), there is a burden to develop high speed, high capacity signal detection. Some detection schemes use increased power alternating between primary and secondary synchronization channels to get a non-coherent detection. According to one alternative scheme, two channel signals are alternated in a given slot.

What is desired is a way of detecting (and differentiating) primary synchronization channel transmissions with less computational effort and with greater efficiency than required with correlation techniques.

### SUMMARY OF THE INVENTION

One aspect of the present invention is the use of a channel transmission detection method that uses a coherent addition technique.

A further aspect of the present invention is to detect the primary synchronization channel transmission signal.

The primary synchronization channel (PSCH) contains the same information, repeated multiple times over a brief time period. A single frame contains fifteen slot blocks of data, including PSCH in the front, transmitted in a 10 ms time period. Instead of using one of the correlation algorithms, the present invention uses coherent addition of the repetitive components found in the PSCH.

Additional objects and advantages of the present invention will be apparent in the following detailed description read in conjunction with the accompanying drawing figures.

### BRIEF DESCRIPTION OF THE DRAWINGS

FIG. 1 illustrates a primary synchronization channel positioning within a signal block occupying a time slot.

FIG. 2 illustrates a synchronous channel structure.

### DETAILED DESCRIPTION OF THE INVENTION

A method embodiment of the present invention detects a repetitive wireless signal. According to this method, a plurality of signal blocks are received within a radio frequency bandwidth and are sampled over time. The signal block samples are analyzed for repetitive elements using coherent addition. Based on this analysis, the repetitive elements of the signal block samples are isolated so as to detect transmission of a repetitive wireless signal from a wireless transmitter.

The present invention is also advantageously embodied as an apparatus implementing the method as described.

The present invention was developed in the context of attempting to improve performance of receiver detection of a 3G WCDMA Primary Synchronization Channel signal. The present invention improves detection performance using coherent addition.

The invention has been implemented and successfully practice by incorporating the disclosed method in software executing on a Texas Instruments TMS320VC5416 fixed-point processor used in a 3G WCDMA receiver built by Dynamic Telecommunications, Inc. of Germantown, Md. Although this is an example of one way of implementing the invention, this specific implementation is not meant to be a limitation on the scope of an invention that may be implemented using a wide variety of processors in the communication equipment provided by any manufacturer. The processing of the present invention can function on single purpose equipment (purpose-built) or other equipment having processing capabilities similar to the Texas Instruments TMS320VC5416 fixed-point processor. A VSLI chip, with or without auxiliary memory, may also be sufficient to perform the necessary processing. The processor and memory configuration may be selected from any combination of processors and memories compatible with a selected receiver without limitation.

Addition of multiple samples of white Gaussian noise that is random results in no discernable signal. That is because the interfering signals cancel one another out on average. Addition of multiple samples of signals containing repetitive coherent elements amidst random noise results in the coherent components becoming detectible, i.e., showing a gain, as the non-coherent components (i.e., interference components) are canceled out.

The present invention uses coherent ensemble addition (or averaging) of time samples that results in a detection gain superior to that provided by standard correlation techniques. The combining of samples before correlation is a far more efficient method than combining multiple correlation results of raw samples. The gain is achieved by increasing the distance of the desired signal's correlation output peak above the correlation output noise floor. In the presence of additive white Gaussian noise (AWGN) the performance gain is 10*log₁₀(number of samples averaged). This performance gain is different and may be greater in the presence of additive deterministic signals.

The Primary Synchronization Channel (PSCH) is repeated multiple times in a short time span, thus lending itself to a coherent additive algorithm. The other interfering signals (besides the AWGN) are structured as pseudorandom noise signals that cancel each other out just like truly random noise, even when added over a short time period sampling. The components or elements contained in the PSCH transmission will show some significant amplitude whereas the other, non-coherent elements have low level or no amplitude. Thus, the PSCH is readily detected utilizing this methodology.

According to a first embodiment of the present invention, detection of the PSCH in a 3G WCDMA signal is effected. The PSCH is a 256 chip code that occurs at the beginning of every 2560 chip time slot in the signal. There is one frame ever 10 ms and 15 time slots per frame. Other signals, such as pilot channels, control channels, and secondary synchronization channel signals, are code domain multiplexed with the PSCH. Additive noise, multiplicative effects, and the presence of strong interfering signals may also degrade the received signal. In this embodiment, the signal is complex sampled at 2 times the chip rate resulting in one pair of in-phase/quadrature-phase (I/Q) samples being input to the DSP at the rate of 7.68×10⁶ complex samples per second. The sampling clock is accurate to approximately 10⁻⁸ and the sampling can be treated as synchronous sampling for short time durations, thus allowing the coherent addition gain improvement.

According to a working example of this embodiment, 16 blocks of 5120 components are added resulting in approximately a 12 dB improvement in detection capability over that achieved with simple correlation of a single time slot.

This first embodiment of the present invention has the fastest processor execution time and requires a relatively small amount of memory. This embodiment accumulates and averages the value of an element within a block across all the sampled blocks. This averaging is repeated for each element. The algorithm performs a binary shift of the value before accumulating the value to a running total. Effectively, the shift operation divides the value by some power of two.

For example, a four-bit shift divides the value by 16 (2⁴=16). In order to implement this embodiment, the number of sample blocks must equal to two raised to an integer power. The magnitude of the shift being that power of two required to equate to the number of blocks sampled. The advantage of this algorithm is that processors perform bit shift operations rapidly and the storage requirement for the specific in a limited memory space.

The number of blocks added is restricted to be a power of 2, improving execution time and allowing this implementation to dovetail well with known sample collection routines. The faster execution time allows this implementation to execute while samples are continuously collected.

Let:

n=the number of data blocks to be added=2^{m}, where m is an integer

x(i,k)=element number i of the input sample block number k

Y(i)=element number i of the sum block

Then:

$$Y ( i ) = {\sum }_{k = 1}^{n} ( x ( i , k ) >> {log}_{2} ( n ) ) ; for i = 0 to block length - 1$$

The initial shift of the input samples allows the addition to be performed recursively and allows the running accumulations to be stored in 16-bit wide memory. A disadvantage of this method is that dynamic range is lost because of the initial right shift of the input elements. With low received signal levels the input samples may be reduced to a small value or 0 by the right shift resulting in no performance gain or even an overall performance loss.

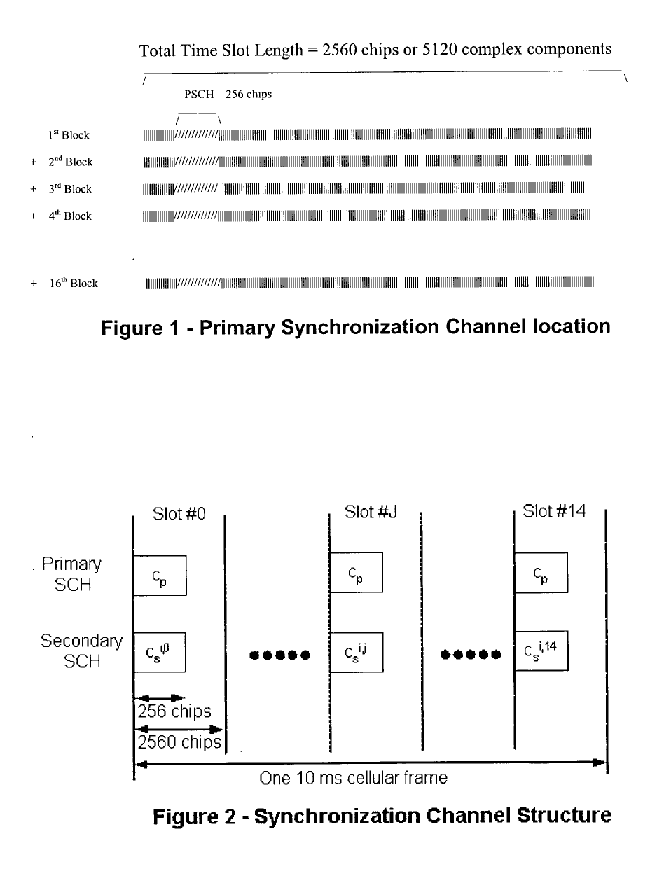

Referring to FIG. 1, the primary synchronization channel, PSCH, is illustrated as being present at the beginning of each block. PSCH is graphically represented with diagonal (///) lines. The balance of the block is graphically represented with vertical (||||) lines. The diagonal lines are repetitive in content from block to block. A block represents a time slot of transmission, wherein 15 slots of code are transmitted in a 10 ms period. Each slot of code, one block in the illustration, is 2560 chips in length, or, when utilizing quadrature phase shift keying (QPSK), a complex block of code of 5120 components results.

As depicted in FIG. 1, each of sixteen blocks of complex components is added. There is nothing requiring sixteen blocks being summed. The first embodiment does require the number of sample blocks summed to be equal to two raised to some power. In this illustration, the power is four. When the PSCH repeating code portion of each of the blocks is added and averaged, the signal is detected. The balance of the code tends to be cancelled out because of the pseudo random nature of the signals.

Referring to FIG. 2, synchronization channel structure is illustrated. There are fifteen time slots of code transmitted over a 10 ms cellular frame. Slots are numbered from zero (0) to fourteen (14), as illustrated. Each slot comprises 2560 chips, of which 256 chips are in a synchronization channel. The synchronization channel has a primary and a secondary subchannel. Identical PSCH code, labeled as cₚ, is repeated in each of the slots. The PSCH code is the same for every cell in the system.

The secondary synchronization code (SSCH) comprises fifteen sequences of modulated code with total length of 256 chips. The code, denoted as cs in the figure, carries a superscript in the form of i, j where i ranges from 1 to 64 and represents a unique number for a particular “scrambler code group”. The j superscript refers to the slot number (0 . . . 14). The Cs indicates which code group a cell's downlink belongs.

According to a second, alternative embodiment of the present invention, the value of an individual element is accumulated across all the sample blocks and then the element's cumulative value is divided by the number of sample blocks to derive the average. This implementation is preferably performed recursively so as to produce much the same results as the first embodiment.

In contrast to the first embodiment, however, the running accumulations for the second embodiment are stored as 32 bit integers and the scaling is performed on the result after the accumulations are complete. More memory is required, but the shift operation is dispensed with and a single division operation is performed at the end of the process.

Let:

n=the number of data blocks to be added

x(i,k)=element number i of the input sample block number k

Y(i)=element number i of the sum block

Then:

$$Y ( i ) = {( \sum }_{k = 1}^{n} ( x ( i , k ) ) n ) ; for i = 0 to block length - 1$$

According to a third, alternate embodiment more processor execution time is needed and continuous collection of samples may not be feasible. However, less memory is needed than the second embodiment. This third embodiment of the present invention performs a running average recursively in the form of a simple infinite impulse response (IIR) filter and the taps of the IIR filter are adjusted after each input sample block is accumulated.

For any number of input sample blocks, m,

Let:

n=1 to total number of input blocks, n=1, 2, 3, . . . , m

Y(n,i)=element number i of the output accumulation block after the accumulation of n input blocks

x(n,i)=element number i of input sample block number n

Then:

Y(n,i)=a(n)*x(n,i)+b(n)* Y(n−1,i); for i=0 to block length−1

Where:

a(n)=1/n and b(n)=1−a(n)

According to a fourth, alternate embodiment averaging is performed in an adaptable mode across a varying number of blocks until PSCH is acquired. This approach may be used to minimize intolerance for frequency offset. The more timeslots that are averaged the less frequency tolerant the system may become. If this problem arises, this embodiment provides a solution by using an approach that is adaptable.

This embodiment is implemented using the following algorithm. Initially an attempt is made to acquire the PSCH using four block averaging (four block provides a 6 dB processing gain). If the PSCH is detected, then there is no need to go further. However, if the PSCH is not detected, then an attempt is made to acquire the PSCH using eight block averaging (eight block provides a 9 dB processing gain). If the PSCH is then detected, then there is no need to go further. However, if the PSCH is not detected, then an attempt is made to acquire the PSCH using sixteen block averaging (sixteen block provides a 12 dB processing gain). If the PSCH is then detected, then there is no need to go further. If not, then a report is made that PSCH cannot be detected.

This fourth, alternate embodiment provides an additional degree of practicality for field applications. The 4-8-16 progression is simply an example, and this adaptable algorithm may be advantageously implemented using other numbers of blocks.

An efficient method of signal detection in a cellular system using repetitive components has now been illustrated. It is important to note that while a particular addition and averaging of coherent components was described in the various embodiments (e.g., shifting the bit representation to the right) this is not meant as a limitation. For example cumulating the signal component values and subsequently dividing by the number of blocks sampled will work and be within the scope of the described invention. It will be apparent to those skilled in the art that various other modifications, variations, and improvements can be accomplished without departing from the scope of the invention as disclosed.

What is claimed is:

1. A method of detecting a repetitive wireless signal comprising:
receiving a plurality of signal blocks within a radio frequency bandwidth;
sampling the signal blocks over time;
analyzing the signal block samples for repetitive elements using a coherent addition means; and
isolating the repetitive elements of the signal block samples so as to detect transmission of a repetitive wireless signal from a wireless transmitter.

2. The method of claim 1, wherein the repetitive elements isolated correspond to a primary synchronization channel.

3. The method of claim 2, wherein the receiving comprises receiving wideband code division multiple access signal blocks.

4. The method of claim 1, wherein the analyzing comprises:
summing an element within a sampled block across multiple sampled blocks,
obtaining an average value for that element, and
repeating the obtaining an average value for each individual element within the sampled block.

5. The method of claim 4, wherein the number of signal blocks sampled is a positive integer, n, wherein n is restricted to an integer that can be expressed as 2 raised to a power, m, where m is a positive integer, the method further comprising:
right shifting the binary representation of each of the signal block samples by m places; and
accumulating all n of the right shifted samples across the n sampled signal blocks to produce the average value for each element sampled in the signal blocks.

6. The method of claim 4, wherein the number of signal blocks sampled is a positive integer, n, the method further comprising:
dividing each sampled block's element value by n, and
accumulating all of the n divided values thereby resulting in the average element value after all n samplings.

7. The method of claim 4, wherein the number of sampled blocks is a positive integer, n, the method further comprising:
performing a running total average for an element within each of the sampled sample blocks across all sampled signal blocks and for all elements within sampled signal blocks.

8. The method of claim 4, wherein the average is initially obtained across four blocks;
wherein, in the event that the repetitive elements of the signal block samples are not successfully isolated using averaging across four blocks, the average is then obtained across eight blocks; and
wherein, in the event that the repetitive elements of the signal block samples are not successfully isolated using averaging across eight blocks, the average is then obtained across sixteen blocks.

9. The method of claim 4, wherein the average is initially obtained using 6 dB processing gain;
wherein, in the event that the repetitive elements of the signal block samples are not successfully isolated using 6 dB processing gain, the average is then obtained using 9 dB processing gain; and
wherein, in the event that the repetitive elements of the signal block samples are not successfully isolated using 9 dB processing gain, the average is then obtained using 12 dB processing gain.

10. An apparatus for detecting a repetitive wireless signal comprising:
a radio frequency receiver adapted to receive a plurality of signal blocks within a radio frequency bandwidth;
a sampler adapted to sample the received signal blocks over time;
a processor; and
a memory in addressable communication with the processor, the memory bearing software instructions adapted to cause the processor to implement the steps of:
analyzing the signal block samples for repetitive elements using a coherent addition means; and
isolating the repetitive elements of the signal block samples so as to detect transmission of a repetitive wireless signal from a wireless transmitter.

11. The apparatus of claim 10, wherein the repetitive elements isolated correspond to a primary synchronization channel.

12. The apparatus of claim 11, wherein the receiving comprises receiving wideband code division multiple access signal blocks.

13. The apparatus of claim 12, wherein the software instructions are further adapted so that the step of analyzing comprises:
summing an element within a sampled block across multiple sampled blocks,
obtaining an average value for that element, and
repeating the obtaining an average value for each individual element within the sampled block.

14. The apparatus of claim 13, wherein the number of signal blocks sampled is a positive integer, n, wherein n is restricted to an integer that can be expressed as 2 raised to a power, m, where m is a positive integer, and
wherein the software instructions are further adapted to include the steps:
right shifting the binary representation of each of the signal block samples by m places; and
accumulating all n of the right shifted samples across the n sampled signal blocks to produce the average value for each element sampled in the signal blocks.

15. The apparatus of claim 13, wherein the number of signal blocks sampled is a positive integer, n, and
wherein the software instructions are further adapted to include the steps:
dividing each sampled block's element value by n, and
accumulating all of the n divided values thereby resulting in the average element value after all n samplings.

16. The apparatus of claim 13, wherein the number of sampled blocks is a positive integer, n, and
wherein the software instructions are further adapted to include the step:
performing a running total average for an element within each of the sampled sample blocks across all sampled signal blocks and for all elements within sampled signal blocks.
